(19) United States
(12) Patent Application Publication
(10) Pub. No.: US 2025/0218013 A1
(43) Pub. Date: Jul. 3, 2025

(54) METHOD AND APPARATUS FOR GENERATING HUMAN BODY DEPTH MAP, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Fasheng CHEN, Shenzhen (CN); Wen CHENG, Shenzhen (CN); Xiang HE, Shenzhen (CN); Liang ZENG, Shenzhen (CN); Yishi JIANG, Shenzhen (CN); Huizhi ZHOU, Shenzhen (CN); Chang LIU, Shenzhen (CN)

(21) Appl. No.: 19/055,443

(22) Filed: Feb. 17, 2025

Related U.S. Application Data
(63) Continuation of application No. PCT/CN2023/129954, filed on Nov. 6, 2023.

(30) Foreign Application Priority Data
Jan. 17, 2023 (CN) 202310108634.8

(51) Int. Cl. G06T 7/50; G06T 11/20

(52) U.S. Cl. CPC G06T 7/50; G06T 11/203; G06T 2207/30196

(57) ABSTRACT

A method for generating a human body depth map includes: acquiring a skeletal point position of each skeletal point in a skeleton of a target object in a two-dimensional image coordinate system, and acquiring a distance from each skeletal point to a camera imaging plane in a three-dimensional camera coordinate system; acquiring a blank canvas for drawing a human body depth map; determining a depth value of each first pixel point of the skeleton based on the skeletal point position and the distance of each skeletal point; and drawing in the blank canvas based on the depth value of each first pixel point, to obtain a human body depth map of the target object.

### CROSS-REFERENCES TO RELATED APPLICATIONS

This application is a continuation application of PCT Patent Application No. PCT/CN2023/129954, filed on Nov. 6, 2023, which claims priority to Chinese Patent Application No. 2023101086348 filed on Jan. 17, 2023, both of which are incorporated herein by reference in their entirety.

### FIELD OF THE TECHNOLOGY

The present disclosure relates to the field of image processing technologies, and in particular, to a method and an apparatus for generating a human body depth map, an electronic device, a computer-readable storage medium, and a computer program product.

### BACKGROUND OF THE DISCLOSURE

A human body depth map is often generated by using a depth estimation algorithm based on deep learning. Specifically, depth prediction is performed on inputted red (R), green (G), and blue (B) human body images by using a trained deep learning model to obtain the human body depth map. However, training and inference of the deep learning model have a great requirement on hardware resources and are time-consuming. As a result, generation costs of the human body depth map is high and generation efficiency is low.

### SUMMARY

Embodiments of the present disclosure provide a method and an apparatus for generating a human body depth map, an electronic device, a computer-readable storage medium, and a computer program product, which can improve generation efficiency of the human body depth map, and reduce generation costs of the human body depth map.

The technical solutions of the embodiments of the present disclosure are implemented as follows:

An embodiment of the present disclosure provides a method for generating a human body depth map, including: acquiring a skeletal point position of each skeletal point in a skeleton of a target object in a two-dimensional image coordinate system, and acquiring a distance from each skeletal point to a camera imaging plane in a three-dimensional camera coordinate system; acquiring a blank canvas for drawing the human body depth map; determining a depth value of each first pixel point of the skeleton based on the skeletal point position and the distance of each skeletal point; and drawing in the blank canvas based on the depth value of each first pixel point, to obtain a human body depth map of the target object.

An embodiment of the present disclosure further provides an apparatus for generating a human body depth map, including: a first acquisition module, configured to acquire a skeletal point position of each skeletal point in a skeleton of a target object in a two-dimensional image coordinate system, and acquire a distance from each skeletal point to a camera imaging plane in a three-dimensional camera coordinate system; a second acquisition module, configured to acquire a blank canvas for drawing a human body depth map; a determining module, configured to determine a depth value of each first pixel point of the skeleton based on the skeletal point position and the distance of each skeletal point; and a drawing module, configured to draw in the blank canvas based on the depth value of each first pixel point, to obtain a human body depth map of the target object.

An embodiment of the present disclosure further provides an electronic device, including: a memory, configured to store computer-executable instructions; and a processor, configured to perform the method for generating a human body depth map according to the embodiment of the present disclosure when executing the computer-executable instructions stored in the memory.

An embodiment of the present disclosure further provides a non-transitory computer-readable storage medium, having computer-executable instructions stored therein, and the computer-executable instructions, when executed by a processor, implement the method for generating a human body depth map provided in this embodiment of the present disclosure.

The embodiments of the present disclosure have the following beneficial effects:

The foregoing embodiment of the present disclosure is applied. First, a skeletal point position of each skeletal point in a skeleton of a target object in a two-dimensional image coordinate system, a distance from each skeletal point to a camera imaging plane in a three-dimensional camera coordinate system, and a blank canvas for drawing a human body depth map are acquired. Then, a depth value of each first pixel point of the skeleton is determined based on the skeletal point position and the distance of each skeletal point, so that drawing is performed in the blank canvas based on the depth value of each first pixel point, to obtain a human body depth map of the target object. In this way, only the skeletal point position of each skeletal point in the skeleton of the target object in the two-dimensional image coordinate system and the distance from each skeletal point to the camera imaging plane in the three-dimensional camera coordinate system need to be calculated, to generate the human body depth map of the target object. Compared with generation of the human body depth map through training and inference of a deep learning model, time consumption, occupation and requirements of hardware resources for the disclosed embodiments are reduced, thereby improving generation efficiency of the human body depth map, and reducing generation costs of the human body depth map.

### BRIEF DESCRIPTION OF THE DRAWINGS

FIG. 1 is a schematic diagram of an architecture of a system 100 for generating a human body depth map according to an embodiment of the present disclosure;

FIG. 2 is a schematic flowchart of a method for generating a human body depth map according to an embodiment of the present disclosure;

FIG. 3 is a schematic diagram of a related coordinate system according to an embodiment of the present disclosure;

FIG. 4 is a schematic structural diagram of a human body skeleton according to an embodiment of the present disclosure;

FIG. 5 is a schematic diagram of a principle of depth value diffusion according to an embodiment of the present disclosure;

FIG. 6 is a schematic flowchart of a method for generating a human body depth map according to an embodiment of the present disclosure;

FIG. 7 is a schematic flowchart of a method for generating a human body depth map according to an embodiment of the present disclosure;

FIG. 8 is a schematic flowchart of a method for generating a human body depth map according to an embodiment of the present disclosure;

FIG. 9 is a schematic flowchart of a method for generating a human body depth map according to an embodiment of the present disclosure;

FIG. 10A and FIG. 10B are schematic diagrams of application of a human body depth map according to an embodiment of the present disclosure;

FIG. 11 is a schematic structural diagram of an apparatus for generating a human body depth map according to an embodiment of the present disclosure; and

FIG. 12 is a schematic structural diagram of an electronic device 500 for implementing a method for generating a human body depth map according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, the “some embodiments” may be the same subset or different subsets of all the possible embodiments, and may be combined with each other without conflict.

In the following descriptions, the included term “first/second/third” is merely intended to distinguish similar objects but does not necessarily indicate a specific order of an object. “First/Second/Third” is interchangeable in terms of a specific order or sequence if permitted, so that the embodiments of the present disclosure described herein can be implemented in a sequence in addition to the sequence shown or described herein.

Unless otherwise defined, meanings of all technical and scientific terms used in this specification are the same as those usually understood by a person skilled in the art to which the present disclosure belongs. Terms used in this specification are merely intended to describe objectives of the embodiments of the present disclosure, but are not intended to limit the present disclosure.

Before the embodiments of the present disclosure are further described in detail, nouns and terms involved in the embodiments of the present disclosure are described. The nouns and terms provided in the embodiments of the present disclosure are applicable to the following explanations.
1) A client is an application running in a terminal and configured to provide various services, for example, a client that supports generating a human body depth map.
2) “In response to” is configured for representing a condition or status on which one or more operations to be performed depend. When the condition or status is satisfied, the one or more operations may be performed immediately or after a set delay. Unless explicitly stated, there is no limitation on the order in which the plurality of operations are performed.
3) Depth map: It records a distance between an object corresponding to each pixel point and a camera imaging plane (that is, a camera imaging focal plane). The depth map can usually correspond to a two-dimensional (2D) image captured by a camera, and an actual distance between the object corresponding to each pixel point in an RGB image and the camera imaging plane can be determined based on the depth map.
4) Virtual Reality (VR) is a technology that includes a computer, electronic information, and simulation technology. The virtual reality is basically implemented based on latest development efforts of various high-tech technologies, such as a three-dimensional (3D) graphics technology, a multimedia technology, a simulation technology, a display technology, and a servo technology, to generate a realistic virtual world with various sensory experiences, such as three-dimensional vision, touch, and smell, by using a device such as a computer, so that a person in the virtual world has an immersive feeling.
5) Virtual-real fusion: It refers to a technology for integrating a real person into a virtual scene. The technology has a wide application field, can be applicable to applications such as video production, live streaming, culture rendering, education, online conference, and interactive game, and shows great promise. Sometimes, it is referred to as virtual photographing, virtual film production, or a real human virtual scene.
6) VR video: It is also referred to as a panoramic video, which refers to a video that can implement a three-dimensional space presentation function and that can be formed by a workman by using a professional VR photography function to realistically record a scene environment, and then post-processing a video by using a computer. Compared with a 2D video, the VR video can bring users a very unique sense of immersion, that is, images that the users see are all three-dimensional.

The embodiments of the present disclosure provide a method and an apparatus for generating a human body depth map, an electronic device, a computer-readable storage medium, and a computer program product, which can improve generation efficiency of the human body depth map, and reduce generation costs of the human body depth map. The following respectively provides descriptions.

When the embodiments of the present disclosure are applicable to specific products or technologies, permission or consent of the users is required, and the collection, use and processing of relevant data need to comply with the relevant laws, regulations and standards of relevant countries and regions.

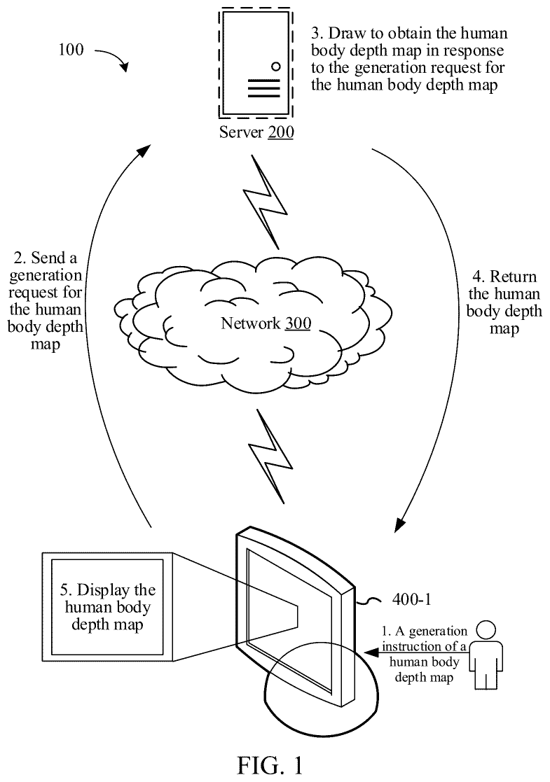

The following describes a system for generating a human body depth map according to an embodiment of the present disclosure. FIG. 1 is a schematic diagram of an architecture of a system 100 for generating a human body depth map according to an embodiment of the present disclosure. To support an exemplary application, a terminal (a terminal 400-1 is shown as an example) is connected to a server 200 through a network 300. The network 300 may be a wide area network or a local area network, or a combination thereof, and uses a wireless or wired link to achieve data transmission.

The terminal (for example, 400-1) is configured to send a generation request for a human body depth map of a target object to the server 200 in response to a generation instruction of the human body depth map of the target object. The server 200 is configured to: receive the generation request for the human body depth map of the target object sent by the terminal; acquire, in response to the generation request, a skeletal point position of each skeletal point in a skeleton of the target object in a two-dimensional image coordinate system, and acquire a distance from each skeletal point to a camera imaging plane in a three-dimensional camera coordinate system; acquire a blank canvas for drawing the human body depth map; determine a depth value of each first pixel point of the skeleton based on the skeletal point position and the distance of each skeletal point; draw in the blank canvas based on the depth value of each first pixel point, to obtain the human body depth map of the target object; and return the human body depth map of the target object to the terminal. The terminal (for example, 400-1) is further configured to: receive the human body depth map of the target object returned by the server 200; and display the human body depth map of the target object.

In some embodiments, the method for generating a human body depth map provided in the embodiments of the present disclosure may be implemented by various electronic devices, for example, may be separately implemented by a terminal, or may be separately implemented by a server, or may be collaboratively implemented by a terminal and a server. The method for generating a human body depth map provided in the embodiments of the present disclosure may be applicable to various scenarios, including but not limited to, cloud technology, artificial intelligence, intelligent transportation, assisted driving, games, audio and video, VR, virtual-real fusion, or the like.

In some embodiments, an electronic device for implementing the method for generating a human body depth map provided in the embodiments of the present disclosure may be various types of terminals or servers. The server (for example, the server 200) may be an independent physical server, or may be a server cluster including a plurality of physical servers or a distributed system. The terminal (for example, the terminal 400-1) may be a smartphone, a tablet computer, a notebook computer, a desktop computer, a smart speech interaction device (for example, a smart speaker), a smart household appliance (for example, a smart television), a smartwatch, an in-vehicle terminal, a wearable device, a VR device, or the like, but is not limited thereto. The terminal and the server may be directly or indirectly connected in a wired or wireless communication manner. This is not limited in the embodiments of the present disclosure.

In some embodiments, the method for generating a human body depth map according to an embodiment of the present disclosure may be implemented by using a cloud technology. The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. A cloud computing technology becomes an important support. A background service of a technical network system requires a large amount of computing resources and storage resources. In an example, the server (for example, the server 200) may alternatively be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In some embodiments, a plurality of servers may form a blockchain, and the servers are nodes on the blockchain. There may be information connections among the nodes on the blockchain, and the nodes may transmit information through the information connections. Data (for example, a human body depth map, a skeletal point position of each skeletal point in a skeleton in a two-dimensional image coordinate system, and a distance from each skeletal point to a camera imaging plane in a three-dimensional camera coordinate system) related to the method for generating a human body depth map provided in the embodiments of the present disclosure may be stored on the blockchain.

In some embodiments, the terminal or server may implement the method for generating a human body depth map provided in the embodiments of the present disclosure by running a computer program. For example, the computer program may be a native program or a software module in an operating system; may be a native application (APP), that is, a program that needs to be installed in an operating system to run; or may be an applet, that is, a program that only needs to be downloaded into a browser environment to run; or may be an applet that can be embedded into any APP. In conclusion, the foregoing computer program may be any form of an application, a module, or a plug-in.

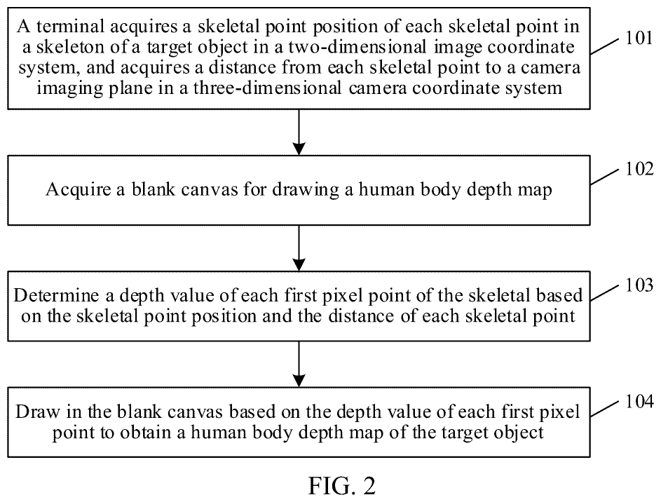

The method for generating a human body depth map provided in the embodiments of the present disclosure is described below. In some embodiments, the method for generating a human body depth map provided in the embodiments of the present disclosure may be implemented by various electronic devices, for example, may be separately implemented by a terminal, or may be separately implemented by a server, or may be collaboratively implemented by a terminal and a server. An example in which the method is implemented by a terminal is used. FIG. 2 is a schematic flowchart of a method for generating a human body depth map according to an embodiment of the present disclosure. The method for generating a human body depth map provided in the embodiments of the present disclosure includes:

Operation 101: A terminal acquires a skeletal point position of each skeletal point in a skeleton of a target object in a two-dimensional image coordinate system, and acquires a distance from each skeletal point to a camera imaging plane in a three-dimensional camera coordinate system.

Herein, the terminal may be provided with a client, and the client may be a client that supports in generating the human body depth map. The terminal runs the client in response to a running instruction for the client. When the terminal receives a generation instruction for a human body depth map of the target object, the terminal acquires, in response to the generation instruction, information required for generating the human body depth map of the target object: the skeletal point position of each skeletal point in the skeleton of the target object in the two-dimensional image coordinate system and the distance from each skeletal point to the camera imaging plane in the three-dimensional camera coordinate system. The distance from each skeletal point to the camera imaging plane is actually a depth value of each skeletal point at a first pixel point on a skeleton drawing region.

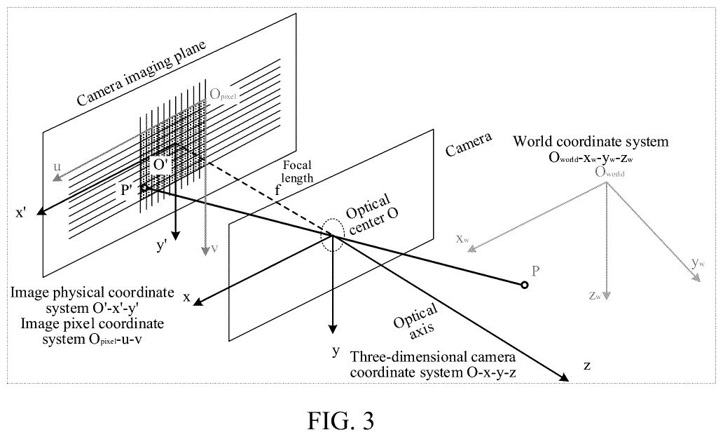

FIG. 3 is a schematic diagram of a related coordinate system according to an embodiment of the present disclosure. 1) Description of a world coordinate system. The world coordinate system is a three-dimensional coordinate system established by using any point as a center of a circle in three-dimensional space of a real world, which is also referred to as a three-dimensional world coordinate system, and is an absolute coordinate system of an objective three-dimensional world. The world coordinate system changes with a size and a position of an object, and a unit is a length unit. Because a camera is placed in the three-dimensional space, the world coordinate system is used as a reference coordinate system to describe a position of the camera, and is used to describe a position of any other object placed in a three-dimensional environment.
2) Description of a camera coordinate system. The camera coordinate system is a three-dimensional rectangular coordinate system, that is, the three-dimensional camera coordinate system in the embodiments of the present disclosure, where an optical center of the camera is used as an origin O of a coordinate system, an x-axis and a y-axis are respectively parallel to two vertical sides of the camera imaging plane, that is, x and y directions parallel to an image are used as the x-axis and the y-axis, an optical axis of the camera is used as a z-axis (or the z-axis is parallel to the optical axis), and x, y, and z directions are perpendicular to each other, where units thereof are length units.
3) Description of an image physical coordinate system. The image physical coordinate system uses an intersection point between the optical axis of the camera and the camera imaging plane as a coordinate origin O′, and an x′-axis and a y′-axis are respectively parallel to two vertical sides of the camera imaging plane, where units thereof are length units.
4) Description of an image pixel coordinate system (that is, the two-dimensional image coordinate system in the present disclosure). The image pixel coordinate system uses a vertex of an image as a coordinate origin O^{pixel}, and u and v directions are parallel to directions of an x′-axis and a y′-axis, which are in units of pixels. Herein, an image acquired by the camera first forms a standard electrical signal, and then is converted into a digital image through analog-to-digital conversion. Each image is stored in an M×N array, and a value of each element in the image of M rows and N columns represents a grayscale of an image point. Each element is referred to as a pixel, and the image pixel coordinate system is a two-dimensional image coordinate system in units of pixels.

Conversion between the foregoing coordinate systems is described. A process of imaging a geometric object P by the camera is as follows: three-dimensional coordinates P_{w} (x_{w}, y_{w}, z_{w}) of the geometric object P in the world coordinate system are acquired and three-dimensional coordinates Pₒ (x, y, z) of P_{w} in the three-dimensional camera coordinate system are obtained through rigid body transformation, and then coordinates p′ (x′, y′) of a projected point of the coordinates Pₒ in the image physical coordinate system are obtained through projection transformation, and finally, coordinates p (u, v) of the coordinates p′ in the image pixel coordinate system are obtained through discretization processing.

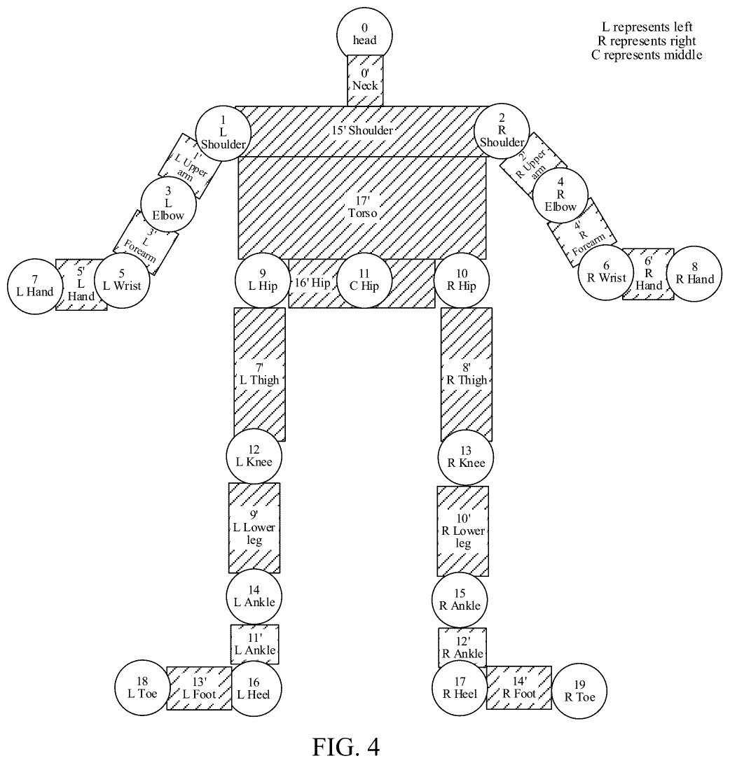

In an example, FIG. 4 is a schematic structural diagram of a human body skeleton according to an embodiment of the present disclosure. Herein, 17′ (torso) is a quadrangular skeletal region of the human body skeleton formed by connecting points 1 (L shoulder), 2 (R shoulder), 9 (L hip), and 10 (R hip), and other limbs are skeletal line segments of the human body skeleton, for example, 7′ (L thigh) and 8′ (R thigh) are both skeletal line segments. Circles in FIG. 4 represent skeletal points, for example, the skeletal point 10 (R hip) and a skeletal point 13 (R knee).

Operation 102: Acquire a blank canvas for drawing a human body depth map.

In the embodiments of the present disclosure, the human body depth map is acquired by drawing in the blank canvas. Therefore, when the human body depth map of the target object is generated, the blank canvas for drawing the human body depth map further needs to be acquired, that is, a blank canvas is initialized. In some embodiments, the terminal may acquire the blank canvas for drawing the human body depth map in the following manner: acquiring a target resolution of a to-be-generated human body depth map; and creating a blank canvas having the target resolution and for drawing the human body depth map. In actual application, a resolution of the blank canvas is consistent with a resolution of the to-be-generated human body depth map. To be specific, the resolution of the to-be-generated human body depth map is the target resolution, and the resolution of the blank canvas is also the target resolution. In this way, it can be ensured that the generated human body depth map is of the required target resolution, thereby improving an effect of generating the human body depth map.

Operation 103: Determine a depth value of each first pixel point of the skeleton based on the skeletal point position and the distance of each skeletal point.

Herein, after the skeletal point position of the skeletal point in the skeleton of the target object and the distance from each skeletal point to the camera imaging plane are acquired, the depth value of each first pixel point of the skeleton of the target object is calculated based on the skeletal point position of each skeletal point in the skeleton of the target object and the distance from each skeletal point to the camera imaging plane. Each first pixel point of the skeleton is each first pixel point of the skeleton in the skeleton drawing region when the skeleton is drawn into the skeleton drawing region in the blank canvas. In the embodiments of the present disclosure, a depth value of a pixel point may also be understood as a color value or a grayscale value of the pixel point.

In some embodiments, the skeleton is formed by connecting a plurality of skeletal line segments, and two endpoints of the skeletal line segment are respectively a first skeletal point and a second skeletal point in the skeleton. Correspondingly, based on the skeletal point position and the distance of each skeletal point, the terminal may determine the depth value of each first pixel point of the skeleton in the following manner: respectively performing the following processing for each skeletal line segment point on each of the plurality of skeletal line segments in the skeleton, to obtain the depth value of each first pixel point of the skeleton: acquiring a line segment point position of the skeletal line segment point in the two-dimensional image coordinate system; determining a first distance between the skeletal line segment point and the first skeletal point based on the line segment point position and a skeletal point position of the first skeletal point; determining a second distance between the skeletal line segment point and the second skeletal point based on the line segment point position and a skeletal point position of the second skeletal point; and determining the depth value of the first pixel point of the skeletal line segment point based on the first distance, the second distance, a distance from the first skeletal point to the camera imaging plane, and a distance from the second skeletal point to the camera imaging plane.

The skeleton is formed by connecting the plurality of skeletal line segments, for example, referring to FIG. 4, the skeletal line segment 7′ (L thigh) and the skeletal line segment 8′ (R thigh). Two endpoints of each skeletal line segment are skeletal points. For example, two endpoints of the skeletal line segment 8′ shown in FIG. 4 are the skeletal point 10 (R hip) and the skeletal point 13 (R knee). The two endpoints of the skeletal line segment may be referred to as the first skeletal point and the second skeletal point in the skeleton. When the depth value of each first pixel point of the skeleton is determined, for each skeletal line segment point on each skeletal line segment in the skeleton, the depth value of the first pixel point of each skeletal line segment point may be determined, and the skeletal line segment point and the first pixel point are in a one-to-one correspondence. In other words, the depth value of the first pixel point of each skeletal line segment point on each skeletal line segment in the skeleton forms the depth value of each first pixel point of the skeleton. The skeletal line segment point is a point randomly sampled or sampled at a preset sampling rate on the skeletal line segment, the sampled skeletal line segment point forms the skeletal line segment, and one skeletal line segment point may be equivalent to one pixel point. The endpoints of the skeletal line segment (that is, the first skeletal point and the second skeletal point) are also skeletal line segment points. Specifically, when the depth value of the first pixel point of each skeletal line segment point is determined, the following processing may be performed for each skeletal line segment point on each skeletal line segment in the skeleton:

First, the line segment point position of the skeletal line segment point in the two-dimensional image coordinate system is acquired. Then, the first distance between the skeletal line segment point and the first skeletal point is determined based on the line segment point position and the skeletal point position of the first skeletal point (the first skeletal point of the skeletal line segment at which the skeletal line segment point is located). In addition, the second distance between the skeletal line segment point and the second skeletal point is further determined based on the line segment point position and the skeletal point position of the second skeletal point (the second skeletal point of the skeletal line segment at which the skeletal line segment point is located). Finally, the depth value of the first pixel point of the skeletal line segment point is determined based on the first distance, the second distance, the distance from the first skeletal point to the camera imaging plane, and the distance from the second skeletal point to the camera imaging plane. During actual implementation, the distance from the first skeletal point to the camera imaging plane is actually a depth value of a first pixel point of the first skeletal point, and the distance from the second skeletal point to the camera imaging plane is actually a depth value of a first pixel point of the second skeletal point.

In some embodiments, based on the first distance, the second distance, the distance from the first skeletal point to the camera imaging plane, and the distance from the second skeletal point to the camera imaging plane, the terminal may determine the depth value of the first pixel point of the skeletal line segment point in the following manner: using the first distance as a first weight value of the distance from the first skeletal point to the camera imaging plane, and using the second distance as a second weight value of the distance from the second skeletal point to the camera imaging plane; performing weighted averaging processing on the distance from the first skeletal point to the camera imaging plane and the distance from the second skeletal point to the camera imaging plane based on the first weight value and the second weight value, to obtain a weighted averaging result; and using the weighted averaging result as the depth value of the first pixel point of the skeletal line segment point.

Herein, the depth value of the first pixel point of the skeletal line segment point=(the first weight value*the distance from the first skeletal point to the camera imaging plane+the second weight value*the distance from the second skeletal point to the camera imaging plane)/(the first weight value+the second weight value). The first weight value is a first distance between the skeletal line segment point and the first skeletal point, and the second weight value is a second distance between the skeletal line segment point and the second skeletal point.

Based on the foregoing embodiment, the depth value of the first pixel point of the skeletal line segment point on each skeletal line segment in the skeleton can be determined based on the skeletal point position of each skeletal point and the distance from each skeletal point to the camera imaging plane. In this way, the skeletal depth map can be preferentially drawn based on the depth value of the first pixel point of each skeletal line segment point, so as to quickly generate the human body depth map and improve the generation efficiency of the human body depth map.

A manner of determining the depth value of the first pixel point corresponding to the skeletal line segment is described above. However, in some embodiments, in addition to the skeletal line segment, the human body skeleton further includes a polygonal skeletal region enclosed by at least three skeletal line segments, for example, the “17′ torso” shown in FIG. 4. Therefore, a depth value of the first pixel point corresponding to the polygonal skeletal region further needs to be determined, which is described below.

In some embodiments, the skeleton is formed by connecting the plurality of skeletal line segments, and the skeleton includes: a polygonal skeletal region enclosed by at least three skeletal line segments connected by skeletal points, where vertexes of the polygonal skeletal region are the skeletal points. Correspondingly, based on the skeletal point position and the distance of each skeletal point, the terminal may determine the depth value of each first pixel point of the skeleton in the following manner: dividing the polygonal skeletal region into at least one triangular skeletal region, and respectively performing the following processing for each triangular skeletal region to obtain the depth value of each first pixel point of the polygonal skeletal region of the skeleton: determining the depth value of each first pixel point of the triangular skeletal region of the skeleton based on the skeletal point position of each vertex of the triangular skeletal region and the distance.

The skeleton is formed by connecting the plurality of skeletal line segments (for example, a skeletal line segment 1-1′-3 and a skeletal line segment 9-7′-12 shown in FIG. 4), and the skeleton includes: a polygonal skeletal region enclosed by at least three skeletal line segments connected by skeletal points. For example, the “17′ torso” shown in FIG. 4 is a quadrangular skeletal region enclosed by connecting four skeletal line segments connected by skeletal points 1, 2, 9, and 10. For determination of the depth value of the first pixel point in the polygonal skeletal region, the polygonal skeletal region may be divided into at least one triangular skeletal region. For example, the quadrangular skeletal region “17′ torso” may be divided into: a triangular skeletal region 1 whose vertexes are respectively skeletal points 1, 2, and 9; and a triangular skeletal region 2 whose vertexes are respectively skeletal points 2, 9, and 10. Then, a depth value of each first pixel point of each triangular skeletal region is determined, to obtain the depth value of each first pixel point of the polygonal skeletal region. Specifically, the polygonal skeletal region is divided into at least one triangular skeletal region, and the following processing is respectively performed for each triangular skeletal region to obtain the depth value of each first pixel point of the polygonal skeletal region of the skeleton: determining the depth value of each first pixel point of the triangular skeletal region based on the skeletal point position of each vertex of the triangular skeletal region and a distance from each vertex to the camera imaging plane. Herein, vertexes of the triangular skeletal region are skeletal points forming the triangular skeletal region.

In some embodiments, the skeletal point position of each vertex of the triangular skeletal region is represented by a skeletal point coordinate value. Correspondingly, based on the skeletal point position of each vertex of the triangular skeletal region and the distance, the terminal may determine the depth value of each first pixel point of the triangular skeletal region of the skeleton in the following manner: respectively performing the following processing for each first pixel point of the triangular skeletal region: acquiring a pixel point coordinate value of the first pixel point in the blank canvas; determining, based on the pixel point coordinate value and the skeletal point coordinate value of each vertex of the triangular skeletal region, a weight value of each vertex corresponding to the first pixel point, the weight value of the vertex being a weight value of a distance from the vertex to the camera imaging plane; performing weighted summation on the distance from each vertex to the camera imaging plane based on the weight value of each vertex corresponding to the first pixel point, to obtain a weighted summation result; and using the weighted summation result as the depth value of the first pixel point of the triangular skeletal region.

In actual application, for a first pixel point with a to-be-determined depth value of the triangular skeletal region, a pixel point coordinate value of the first pixel point in the blank canvas may be acquired, and then a weight value of each vertex corresponding to the first pixel point is determined based on the pixel point coordinate value and the skeletal point coordinate value of each vertex of the triangular skeletal region, the weight value of the vertex being a weight value of a distance from the vertex to the camera imaging plane. Therefore, weighted summation is performed on the distance from each vertex to the camera imaging plane based on the weight value of each vertex corresponding to the first pixel point, to obtain a weighted summation result, and finally the weighted summation result is used as the depth value of the first pixel point of the triangular skeletal region. In an example, the skeletal point coordinate values of the vertexes of the triangular skeletal region are respectively (x0, y0), (x1, y1), (x2, y2), the distances from the vertexes to the camera imaging plane are respectively Y0, Y1, and Y2, and a pixel point coordinate value of the first pixel point with the to-be-determined depth value in the blank canvas is (i, j). In this case, a depth value Y of the first pixel point of the triangular skeletal region may be determined in the following manner:

1) Calculate W0x=y1−y2; 2) Calculate W0y=x2−x1; 3) Calculate W1x=y2−y0; 4) Calculate W1y=x0−x2; 5) Calculate D=(y1−y2)+(x0−x2)+(x2−x1)(y0−y2); 6) Calculate w0=(W0x*(j−x2)+W0y*(i−y2))/D; 7) Calculate w1=(W1x*(j−x2)+W1y*(i−y2))/D; 8) Calculate w2=1.0−w0−w1; and 9) Calculate Y=Y0*w0+Y1*w1+Y2*w2.

Herein, w0, w1, and w2 are weight values of the vertexes corresponding to the first pixel point.

Based on the foregoing embodiment, the depth value of the first pixel point of the polygonal skeletal region in the skeleton may be determined based on the pixel point coordinate value of the first pixel point in the blank canvas, the skeletal point position of the vertex of each triangular skeletal region in the polygonal skeletal region, and the distance from the vertex to the camera imaging plane. In this way, a skeletal depth map can be preferentially drawn based on the depth value of each first pixel point of the polygonal skeletal region, so as to quickly generate the human body depth map and improve the generation efficiency of the human body depth map.

It can be determined whether the depth value of the first pixel point needs to be drawn based on w0, w1, and w2. Only if w0, w1, and w2 are all greater than or equal to zero, the depth value of the first pixel point needs to be drawn. That is, in some embodiments, based on the depth value of each first pixel point, the terminal may draw in the blank canvas to obtain the human body depth map of the target object in the following manner: respectively performing the following processing for the depth value of each first pixel point of the triangular skeletal region: when the weight value of each vertex corresponding to the first pixel point is not less than 0, drawing in the blank canvas based on the depth value of the first pixel point, to obtain the human body depth map of the target object.

In actual application, when the weight value of each vertex corresponding to the first pixel point is not less than 0, the first pixel point is drawn in the blank canvas based on the depth value of the first pixel point, and the skeletal depth map in the human body depth map is obtained. When the skeletal depth map is drawn, the skeletal line segment of the skeleton may be first drawn and then the polygonal skeletal region of the skeleton is drawn. Certainly, the polygonal skeletal region of the skeleton may alternatively be first drawn and then the skeletal line segment is drawn. In actual application, FIG. 4 is merely an example of a skeleton, and a definition of a human body skeleton is not limited to the skeleton shown in FIG. 4. The skeleton may include at least one of the skeletal line segment or the polygonal skeletal region.

Operation 104: Draw in the blank canvas based on the depth value of each first pixel point, to obtain a human body depth map of the target object.

Operation 104 may be implemented through the following operations: drawing each first pixel point in the blank canvas based on the depth value of each first pixel point, to obtain a skeletal depth map; and drawing, based on the depth value of each first pixel point, a second pixel point in a region other than each first pixel point in the skeletal depth map, to obtain the human body depth map of the target object.

Herein, after the depth value of each first pixel point in the skeleton drawing region corresponding to the skeleton in the blank canvas is obtained, each first pixel point is drawn in the blank canvas based on the depth value of each first pixel point, to obtain the skeletal depth map. After the skeletal depth map is obtained through drawing, the second pixel point is further drawn, based on the depth value of each first pixel point, in the region other than each first pixel point in the skeletal depth map, to obtain the human body depth map of the target object. In actual application, except for the skeleton drawing region in which each first pixel point is located, a depth value of each pixel point in another non-skeleton drawing region in the skeletal depth map is not known. In this case, the depth value of each pixel point in the region other than each first pixel point in the skeletal depth map may be determined based on the depth value of each first pixel point that has been drawn, so that the second pixel point is drawn based on the depth value of each pixel point, to obtain the human body depth map of the target object. The human body depth map of the target object is configured for recording an actual distance from a human body part corresponding to each pixel point in the human body depth map to the camera imaging plane.

In some embodiments, based on the depth value of each first pixel point, the terminal may draw each first pixel point in the blank canvas to obtain the skeletal depth map in the following manner: respectively performing the following processing for each first pixel point to obtain the skeletal depth map: determining a to-be-drawn position of the first pixel point (i.e., a candidate position to draw the first pixel point) in the blank canvas, and determining a target pixel point located at the to-be-drawn position from the blank canvas; and determining a depth value of the target pixel point as the depth value of the first pixel point, to draw the first pixel point in the blank canvas.

In actual application, the to-be-drawn position of each first pixel point in the blank canvas may be determined, so that for each first pixel point, the first pixel point is drawn at the to-be-drawn position of the first pixel point based on the depth value of the first pixel point. Specifically, each first pixel point has a corresponding to-be-drawn position in the blank canvas. The to-be-drawn position of the first pixel point in the blank canvas may be equivalent to a position, in the two-dimensional image coordinate system, of a target point corresponding to the first pixel point in the skeleton. After the to-be-drawn position of the first pixel point in the blank canvas is determined, the target pixel point located at the to-be-drawn position is determined from the blank canvas, so that the depth value of the target pixel point is determined as the depth value of the first pixel point, to draw the first pixel point in the blank canvas. In actual implementation, because the blank canvas is blank, the depth value of the target pixel point is generally 0. Herein, the depth value of the target pixel point is set to the depth value of the first pixel point, to draw the first pixel point in the blank canvas. In this way, the drawing of each first pixel point of the skeleton is implemented, to obtain the skeletal depth map.

In some embodiments, before determining the depth value of the target pixel point as the depth value of the first pixel point, the terminal may further perform the following processing: when no pixel point is drawn at the target pixel point, determining that an operation of determining the depth value of the target pixel point as the depth value of the first pixel point is to be performed; or when another pixel point has been drawn at the target pixel point, acquiring a target depth value of the another pixel point that has been drawn at the target pixel point, in response to that the target depth value is greater than the depth value of the first pixel point, determining the depth value of the target pixel point as the depth value of the first pixel point; or keeping the target depth value unchanged in response to that the target depth value is not greater than the depth value of the first pixel point.

In actual application, in a process of drawing each first pixel point in the blank canvas, another pixel point may have been drawn at the target pixel point at the to-be-drawn position. For example, for two skeletal line segments having an intersection point (for example, a skeletal line segment point jointly included in the two skeletal line segments), when a first pixel point of a skeletal line segment point on a second skeletal line segment is drawn, a first pixel point of the intersection point has been drawn when a first pixel point of a skeletal line segment point on a first skeletal line segment is drawn. For another example, when a first pixel point of a triangular skeletal region is drawn, for two triangular skeletal regions with a common edge, when a first pixel point of a first triangular skeletal region is drawn, a first pixel point of the common edge has been drawn when the first pixel point of the first triangular skeletal region is drawn.

In this way, before the first pixel point is drawn at the target pixel point, it is first determined whether another pixel point is drawn at the target pixel point. When no pixel point is drawn at the target pixel point, the first pixel point is drawn at the target pixel point, that is, it is determined that the operation of determining the depth value of the target pixel point as the depth value of the first pixel point is to be performed. When another pixel point has been drawn at the target pixel point, in this case, a target depth value of the another pixel point that has been drawn at the target pixel point is further acquired, and the target depth value is compared with the depth value of the first pixel point. Therefore, when the target depth value is greater than the depth value of the first pixel point, the first pixel point is drawn at the target pixel point, that is, it is determined that the operation of determining the depth value of the target pixel point as the depth value of the first pixel point is to be performed. When the target depth value is not greater than the depth value of the first pixel point, the target depth value is kept unchanged, that is, the first pixel point is not drawn again at the target pixel point. In this way, it can be ensured that a depth value of a pixel point in the drawn human body depth map is maximum, so that the human body depth map is correctly generated.

In some embodiments, based on the depth value of each first pixel point, the terminal may draw the second pixel point in the region other than each first pixel point in the skeletal depth map, to obtain the human body depth map of the target object in the following manner: performing depth value diffusion on the depth value of each first pixel point to each target pixel point in the region other than each first pixel point in the skeletal depth map, to obtain the depth value of each target pixel point; and drawing each target pixel point in the skeletal depth map based on the depth value of each target pixel point, and using the drawn target pixel point as the second pixel point, to obtain the human body depth map of the target object. In actual application, the depth value of each target pixel point may be obtained by performing depth value diffusion on the depth value of each first pixel point to each target pixel point in the region other than each first pixel point in the skeletal depth map. The depth value diffusion may be implemented by using a diffusion algorithm, for example, an ink diffusion algorithm. Therefore, each target pixel point is drawn in the skeletal depth map based on the depth value of each target pixel point, and the drawn target pixel point is the second pixel point. In this way, the human body depth map of the target object is obtained. In this way, through depth value diffusion, pixel point drawing is also performed in a region other than the skeleton, so that the drawn human body depth map is more real, and the effect of generating the human body depth map is improved.

In some embodiments, the depth value diffusion includes N rounds of depth value diffusion. The terminal may perform depth value diffusion on the depth value of each first pixel point to each target pixel point in the region other than each first pixel point in the skeletal depth map, to obtain the depth value of each target pixel point in the following manner: for a first round of depth value diffusion of the N rounds of depth value diffusion, performing depth value diffusion on the depth value of each first pixel point to a neighborhood pixel point of each first pixel point, to obtain a depth value of the neighborhood pixel point of each first pixel point, and using the depth value of the neighborhood pixel point of each first pixel point as a depth value of a first round of target pixel point; and for an i^{th} round of depth value diffusion of the N rounds of depth value diffusion, performing depth value diffusion on a depth value of an (i−1)^{th} round of target pixel point to a neighborhood pixel point of the (i−1)^{th} round of target pixel point, to obtain a depth value of the neighborhood pixel point of the (i−1)^{th} round of target pixel point, and using the depth value of the neighborhood pixel point of the (i−1)^{th} round of target pixel point as a depth value of an i^{th} round of target pixel point, where N and i are integers greater than 0, and N is greater than or equal to i.

In actual application, in the N rounds of depth value diffusion, it needs to be ensured that the depth value is diffused to each pixel point in the region other than each first pixel point in the skeletal depth map, that is, it needs to be ensured that a depth value of each pixel point in the region other than each first pixel point in the skeletal depth map is calculated. In each round of depth value diffusion, the first round of depth value diffusion is used as an example. Depth value diffusion is performed on the depth value of each first pixel point to a neighborhood pixel point of each first pixel point, to obtain a depth value of the neighborhood pixel point of each first pixel point, and the depth value of the neighborhood pixel point of each first pixel point is used as the depth value of the first round of target pixel point. For the i^{th} round of depth value diffusion of the N rounds of depth value diffusion, depth value diffusion is performed on the depth value of the (i−1)^{th} round of target pixel point to the neighborhood pixel point of the (i−1)^{th} round of target pixel point, to obtain the depth value of the neighborhood pixel point of the (i−1)^{th} round of target pixel point, and the depth value of the neighborhood pixel point of the (i−1)^{th} round of target pixel point is used as the depth value of the i^{th} round of target pixel point. In this way, an effect of gradually diffusing the depth value all around is achieved. A quantity of neighborhood pixel points of the first pixel point may be preset. The neighborhood pixel point may be an 8-connected neighborhood pixel point of the first pixel point, a 4-connected neighborhood pixel point, or a target value-connected neighborhood pixel point. This is not limited in the embodiments of the present disclosure.

In some embodiments, the terminal may perform depth value diffusion on the depth value of each first pixel point to the neighborhood pixel point of each first pixel point, to obtain the depth value of the neighborhood pixel point of each first pixel point in the following manner: respectively performing the following processing for each neighborhood pixel point to which the depth value of the first pixel point is diffused: determining at least one target first pixel point whose depth value is diffused to the neighborhood pixel point; and performing weighted averaging processing on the depth value of the at least one target first pixel point, to obtain the depth value of the neighborhood pixel point. Similarly, the terminal may perform depth value diffusion on the depth value of the (i−1)^{th} round of target pixel point to the neighborhood pixel point of the (i−1)^{th} round of target pixel point, to obtain the depth value of the neighborhood pixel point of the (i−1)^{th} round of target pixel point in the following manner: respectively performing the following processing for each neighborhood pixel point to which the depth value of the (i−1)^{th} round of target pixel point is diffused: determining at least one (i−1)^{th} round of target pixel point whose depth value is diffused to the neighborhood pixel point; performing weighted averaging processing on the depth value of the determined at least one (i−1)^{th} round of target pixel point, to obtain the depth value of the neighborhood pixel point. In this way, an effect of depth value diffusion can be improved, so that the drawn human body depth map is more real, and the effect of generating the human body depth map is improved.

In actual application, a to-be-drawn pixel point may be one or more neighborhood pixel points of the first pixel point. Therefore, for each neighborhood pixel point to which the depth value of the first pixel point is diffused, the following processing is respectively performed: First, at least one target first pixel point whose depth value is diffused to the neighborhood pixel point is determined, and then weighted averaging processing is performed on the depth value of the at least one target first pixel point, to obtain the depth value of the neighborhood pixel point. For example, if there is one target first pixel point corresponding to the neighborhood pixel point, a depth value of the neighborhood pixel point is the depth value of the target first pixel point. For another example, if there are three target first pixel points corresponding to the neighborhood pixel point, and depth values of the three target first pixel points are respectively a, b, and c, a depth value of the neighborhood pixel point is d=(a+b+c)/3.

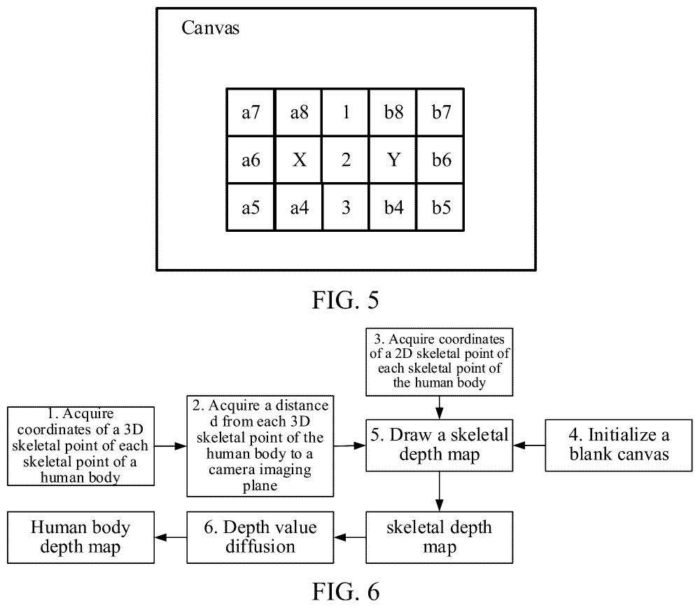

In an example, FIG. 5 is a schematic diagram of a principle of depth value diffusion according to an embodiment of the present disclosure. Herein, in a first round of diffusion, depth value diffusion is respectively performed on depth values of a first pixel point X and a second pixel point Y to 8-connected neighborhood pixel points of the first pixel point X and the second pixel point Y. It can be learned from FIG. 5 that a target first pixel point whose depth value is diffused to the neighborhood pixel points 1, 2, and 3 includes the first pixel point X and the second pixel point Y. Therefore, depth values of the neighborhood pixel points 1, 2, and 3 are: (the depth value of the first pixel point X+the depth value of the second pixel point Y)/2. A target first pixel point whose depth value is diffused to the neighborhood pixel points a4 to a8 is the first pixel point X. Therefore, depth values of the neighborhood pixel points a4 to a8 are the depth value of the first pixel point X. A target first pixel point whose depth value is diffused to the neighborhood pixel points b4 to b8 is the second pixel point Y. Therefore, depth values of the neighborhood pixel points b4 to b8 are the depth value of the second pixel point Y. Sequentially, for each neighborhood pixel point, depth value diffusion may be further performed on the depth value of the neighborhood pixel point to a neighborhood pixel point of the neighborhood pixel point, thereby implementing a second round of depth value diffusion. By analogy, N rounds of depth value diffusion are implemented.

In actual application, in a process of depth value diffusion, there may be a case that a first round of first pixel point is a neighborhood pixel point diffused during an i^{th} (in this case, i is greater than 1) round of depth value diffusion. In this case, during the i^{th} round of depth value diffusion, a depth value of an i^{th} round of target pixel point cannot be diffused to the first round of first pixel point. In addition, during depth value diffusion, it is necessary to determine whether a pixel point diffused this time has been diffused by another pixel point, that is, whether the pixel point diffused this time has a depth value. If a depth value exists, a depth value obtained through this diffusion is compared with the existing depth value. If the depth value obtained through this diffusion is less than the existing depth value, the existing depth value is updated to the depth value obtained through this diffusion. If no depth value exists, a depth value of the pixel point diffused this time is directly set to the depth value obtained through this diffusion.

The foregoing embodiment of the present disclosure is applied. First, a skeletal point position of each skeletal point in a skeleton of a target object in a two-dimensional image coordinate system, a distance from each skeletal point to a camera imaging plane in a three-dimensional camera coordinate system, and a blank canvas for drawing a human body depth map are acquired. Then, a depth value of each first pixel point of the skeleton is determined based on the skeletal point position and the distance of each skeletal point, so that drawing is performed in the blank canvas based on the depth value of each first pixel point, to obtain a human body depth map of the target object. In this way, only the skeletal point position of each skeletal point in the skeleton of the target object in the two-dimensional image coordinate system and the distance from each skeletal point to the camera imaging plane in the three-dimensional camera coordinate system need to be calculated, to generate the human body depth map of the target object. Compared with generation of the human body depth map through training and inference of a deep learning model, time consumption, occupation and requirements of hardware resources for the disclosed embodiments are reduced, thereby improving generation efficiency of the human body depth map, and reducing generation costs of the human body depth map.

An exemplary application of the embodiments of the present disclosure in an actual application scenario is described below. In some application scenarios, a human body depth map is generated by using a monocular depth estimation algorithm based on deep learning. Specifically: 1. A binocular RGB camera is used to capture an RGB image, and a distance between the two cameras is known. 2. An absolute depth under each camera viewing angle is acquired by using a dense matching algorithm, and normalization processing is performed. 3. A deep learning model is trained by using the foregoing data. 4. The RGB image is inputted to the trained deep learning model to predict depth. However, this depth map generation scheme has the following problems: 1) Higher complexity: Training and inference of the deep learning model need to use a GPU, and costs are high. 2) The absolute depth is hard to conveniently acquired: Although the absolute depth can be acquired by using the binocular camera, two cameras need to be used, and costs are high. However, the absolute depth cannot be acquired through depth estimation of the monocular camera. 3) High use threshold: A binocular solution needs to calibrate and correct a position between the two cameras, which is a professional and complex operation. If a depth sensor is used, it is necessary to calibrate a position of the depth sensor and the RGB camera, which is also a professional and complex operation. 4) Higher costs: During VR video photographing, if the binocular solution is used, two sets of cameras and lenses are required, resulting in high photographing hardware costs. If the depth sensor is used, additional purchasing is required. However, even if not considering a defect about only a relative depth could be required in an existing monocular depth estimation algorithm, the existing monocular depth estimation algorithm also requires a GPU to run in real time, which is also hardware overheads. As a result, professional VR cameras for photographing are used in most existing three-dimensional VR video production manners. The VR cameras are expensive, which greatly increases production costs of VR content.

Based on this, an embodiment of the present disclosure provides the method for generating a human body depth map. The absolute depth can be acquired in real time only by using a monocular RGB camera, with low complexity, and can be run in real time by using a single-core CPU, which can provide convenient technical support for virtual-real fusion and VR video production. Based on the method for generating a human body depth map provided in the embodiments of the present disclosure, a three-dimensional VR video with a virtual background may be produced from a 2D picture photographed by using a camera based on a special effect synthesis technology, and an existing camera (for example, a video camera/a mobile phone camera) may be reused. Complex VR photographing devices do not need to be deployed and installed, thereby greatly reducing production costs and thresholds of VR videos. In this way, the method for generating a human body depth map provided in the embodiments of the present disclosure has the following effects: 1) Low complexity & real-time operation: Compared with an existing high-complexity depth estimation algorithm that requires a GPU to run, in this embodiment of the present disclosure, a single-core CPU can be used to run in real time. 2) The absolute depth can be acquired: The existing monocular depth estimation algorithm cannot acquire the depth in real time, which can be achieved in this embodiment of the present disclosure. 3) Economy: During virtual-real fusion and VR video production, a monocular camera can be used without a binocular camera or a depth camera, and an algorithm can be run in real time only by using a CPU, which can save a large amount of hardware costs. 4) Universality: It may be configured for rendering a regular video and a VR video, which can greatly reduce costs and a threshold of VR video production.

The following describes application scenarios of the method for generating a human body depth map provided in the embodiments of the present disclosure, including: (1) Applied to virtual-real fusion, to improve picture perception. In live streaming and video production, a picture of interaction between a real human body and a virtual world can be more real: Limbs of a human body may have a correct occlusion relationship with the virtual world, and there are no revealing mistakes, so that the virtual-real fusion is allowed to support more interaction types, such as gesture control, snow footprints, kicking, and pushing an object. (2) Applied to rendering of a 3D video and a three-dimensional VR video, to improve a 3D effect of a human body in a video. This allows virtual-real fusion of materials that can be photographed by using a monocular camera, to produce a high-quality 3D video and a three-dimensional VR video in which a real-person layer is three-dimensional, thereby greatly reducing production thresholds and costs of the 3D video and the VR video.

The method for generating a human body depth map provided in the embodiments of the present disclosure is described below from a technical perspective. In the embodiments of the present disclosure, the human body depth map is generated based on coordinates of a 2D skeletal point (a 2D skeletal point for short) of each skeletal point in the skeleton of the target object in the two-dimensional image coordinate system and the distance d from 2D skeletal point coordinates of a 3D skeletal point (a 3D skeletal point for short) of each skeletal point in an absolute scale to the camera imaging plane in the three-dimensional camera coordinate system. In the embodiments of the present disclosure, the human body depth map is quickly generated by using a drawing method. Referring to FIG. 6, the method for generating a human body depth map according to an embodiment of the present disclosure includes: 1) Acquiring coordinates of a 3D skeletal point of each skeletal point of a human body; 2) Acquiring a distance d from each 3D skeletal point of the human body to a camera imaging plane; 3) Acquiring coordinates of a 2D skeletal point of each skeletal point of the human body; 4) Initializing a blank canvas; 5) Drawing a skeletal depth map: A skeletal depth map is drawn in the blank canvas based on the distances d corresponding to each 2D skeletal point of the human body and each 3D skeletal point of the human body, to obtain the skeletal depth map; and 6) Depth value diffusion: Depth value diffusion is continuously performed (for example, an ink diffusion algorithm is used) to a surrounding region with an unknown depth value by using a pixel point with a known depth value in the skeletal depth map as a center, to calculate depth values of all pixel points with unknown depth values, to obtain the human body depth map.

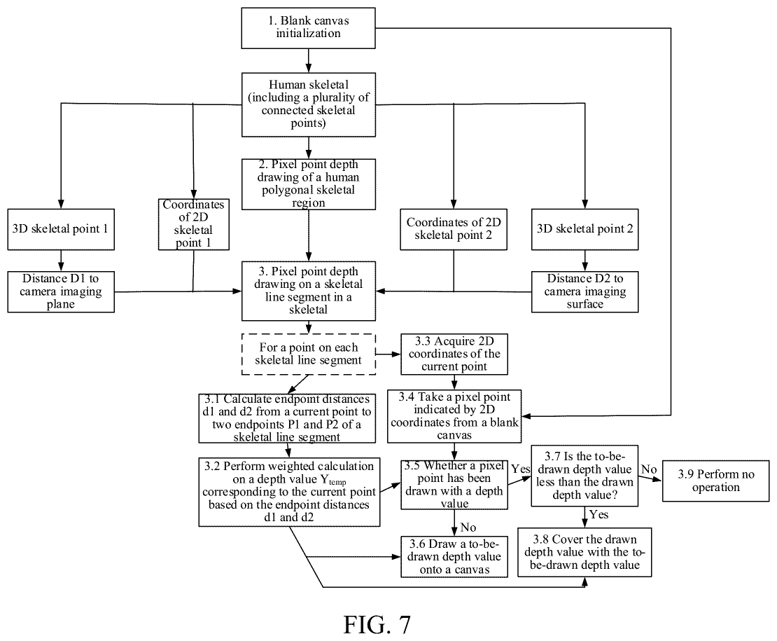

The method for generating a human body depth map provided in the embodiments of the present disclosure may be mainly divided into two operations: draw a skeletal depth map and perform depth value diffusion. First, an implementation of drawing the skeletal depth map is to draw a depth of a skeletal line of a human body on a blank canvas, and cover a larger depth value with a smaller depth value during drawing, to ensure a front-to-rear occlusion relationship. Referring to FIG. 7, a process of drawing a skeletal depth map according to an embodiment of the present disclosure includes:
1. Blank canvas initialization; The resolution of the blank canvas is the same as the resolution of a to-be-generated human body depth map.
2. Pixel point depth drawing of a human polygonal skeletal region. It may be implemented by using a method of pixel point depth drawing of a triangular skeletal region:
a) A torso part (limb 17) is divided into two triangular skeletal regions, and for each triangular skeletal region, pixel point depth drawing is performed by using coordinates of a 2D skeletal point as positions in the blank canvas and a distance D from a 3D skeletal point to a camera imaging plane as a depth value: a1) An outer bounding box of each triangular skeletal region needs to be drawn. a2) When a second triangular skeletal region is drawn, if the to-be-drawn position has been drawn, the following determining is performed: If the depth value that has been drawn is greater than a current to-be-drawn depth value, the depth value that has been drawn is covered with the current to-be-drawn depth value, otherwise, no operation is performed.
3. Pixel point depth drawing on a skeletal line segment in a skeleton. The skeletal line segment is continued to be drawn based on a defined skeletal line segment connection relationship of a human body skeleton. Herein, each skeletal line segment is gradient with a depth value. For each point on each skeletal line segment, the following processing is performed:
3.1) Calculate endpoint distances d₁ and d₂ from a current point to two endpoints P₁ and P₂ of the skeletal line segment; and
3.2) Based on the endpoint distance d₁ and d₂, weighted calculation is performed on a depth value Yₜₑₘₚ corresponding to a current point. A depth value (a distance from a 3D skeletal point to a camera imaging plane) of the endpoint P₁ is recorded as Y₁, and a depth value (a distance from a 3D skeletal point to a camera imaging plane) of the endpoint P₂ is recorded as Y₂. In this case, a calculation formula of Yₜₑₘₚ is:

$${Y}_{temp} = ( {Y}_{1} * {d}_{1} + {Y}_{2} * {d}_{2} ) / ( {d}_{1} + {d}_{2} ) ;$$

3.3) Acquire 2D coordinates of a current point;
3.4) Take a pixel point indicated by 2D coordinates from a blank canvas;
3.5) Whether a pixel point has been drawn with a depth value? if not, 3.6) Draw a to-be-drawn depth value onto a blank canvas; If yes, 3.7) Is the to-be-drawn depth value less than the drawn depth value? if yes, 3.8) Cover the drawn depth value with the to-be-drawn depth value; If not, 3.9) Perform no operation.

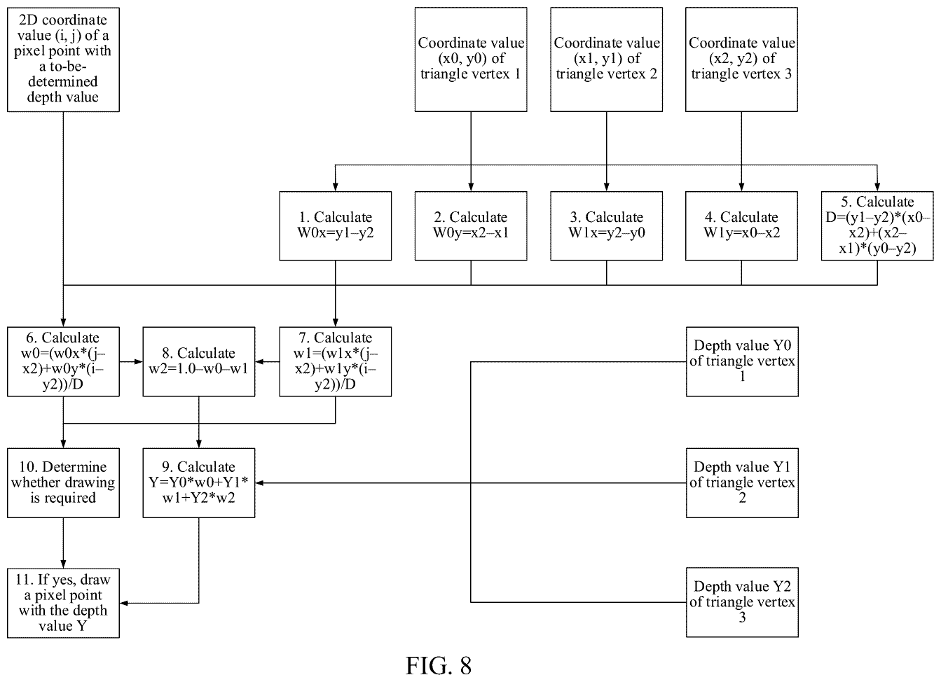

A description of the pixel point depth drawing of the triangular skeletal region is as follows. Referring to FIG. 8, 2D skeletal point coordinate values of vertexes of the triangular skeletal region are respectively (x0, y0), (x1, y1), and (x2, y2), distances (depth values) corresponding to the vertexes are respectively Y0, Y1, and Y2, and a pixel point coordinate value of a pixel point of a to-be-determined depth value of the triangular skeletal region in the blank canvas is (i, j), so that a depth value Y of the pixel point of the triangular skeletal region may be determined through the following operations:
1) Calculate W0x=y1−y2; 2) Calculate W0y=x2−x1; 3) Calculate W1x=y2−y0; 4) Calculate W1y=x0−x2; 5) Calculate D=(y1−y2)(x0−x2)+(x2−x1)(y0−y2); 6) Calculate w0=(W0x*(j−x2)+W0y*(i−y2))/D; 7) Calculate w1=(W1x*(j−x2)+W1y*(i−y2))/D; 8) Calculate w2=1.0−w0−w1; and 9) Calculate Y=Y0*w0+Y1*w1+Y2*w2; 10) It may be determined whether the depth value of the pixel point needs to be drawn (that is, whether the depth value is in the triangular skeletal region) based on w0, w1, and w2. Only if w0, w1, and w2 are all greater than or equal to zero, the depth value of the pixel point may need to be drawn. (11) If yes, draw a pixel point having the depth value Y.

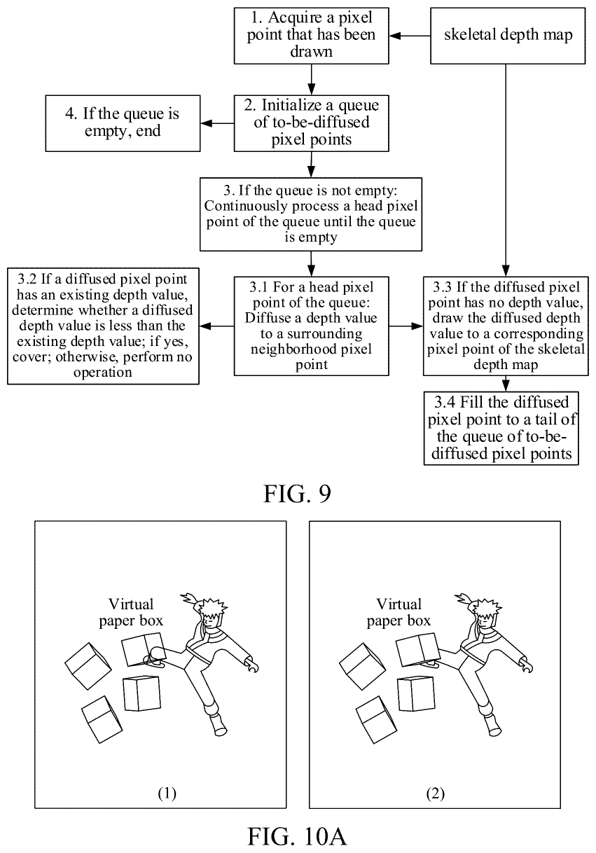

Second, depth value diffusion (calculating a human body depth map with an absolute depth). Herein, the depth value diffusion may be implemented by using an ink diffusion algorithm, that is, based on the skeletal depth that has been drawn on the skeletal depth map, depth value diffusion is performed to a surrounding region with no drawing depth (color), to calculate depths of all pixel points in a region with an unknown depth value. When the human body depth map generated in the embodiments of the present disclosure is used in virtual-real fusion, in virtual-real fusion, only a picture of a human body region is used (a background region is discarded). Therefore, a depth of the background region may be set to any value, and even if the ink diffusion algorithm is used to diffuse to the background region, a picture effect of the virtual-real fusion is not affected. Referring to FIG. 9, a processing procedure of depth value diffusion includes the following operations:
1. Acquire a pixel point that has been drawn from a skeletal depth map.
2. Initialize a queue of to-be-diffused pixel points based on the pixel point that has been drawn. Herein, the pixel points in the skeletal depth map are traversed, and the pixel points that have been drawn with (depth values) are filled one by one into the tail of the queue of to-be-diffused pixel points, to obtain the queue of to-be-diffused pixel points.
3. If the queue of to-be-diffused pixel points is not empty, continuously process a head pixel point in the queue until the queue is empty. A processing process of the head pixel point is as follows:
3.1) Diffuse a depth value to a surrounding neighborhood pixel point by using a current head pixel point in the queue as a center. Herein, the neighborhood pixel point may be an 8-connected neighborhood pixel point, a 4-connected neighborhood pixel point, or another connected neighborhood pixel point. This is not limited herein.
3.2) If a diffused pixel point has an existing depth value (drawn), determine whether a diffused depth value is less than the existing depth value, if yes, cover, otherwise, perform no operation.
3.3) If the diffused pixel point has no depth value (has not been drawn), draw the diffused depth value to a corresponding pixel point of the skeletal depth map.
3.4) Fill the diffused pixel point to a tail of the queue of to-be-diffused pixel points.
4. If the queue is empty, end.

In this way, the blank canvas is to be filled with the depth value. In this case, an absolute depth map of the human body region can be obtained by masking the depth of the human body region in combination with a matting module in virtual-real fusion. Herein, for the ink diffusion algorithm: a) An edge of each diffusion may be considered as a round, and weighted averaging is performed on ink (that is, a depth value) in each round, to further simulate an effect of ink diffusion and improve quality of depth map generation. b) Depth value diffusion is not limited to using the foregoing ink diffusion algorithm, but may alternatively be another diffusion algorithm.

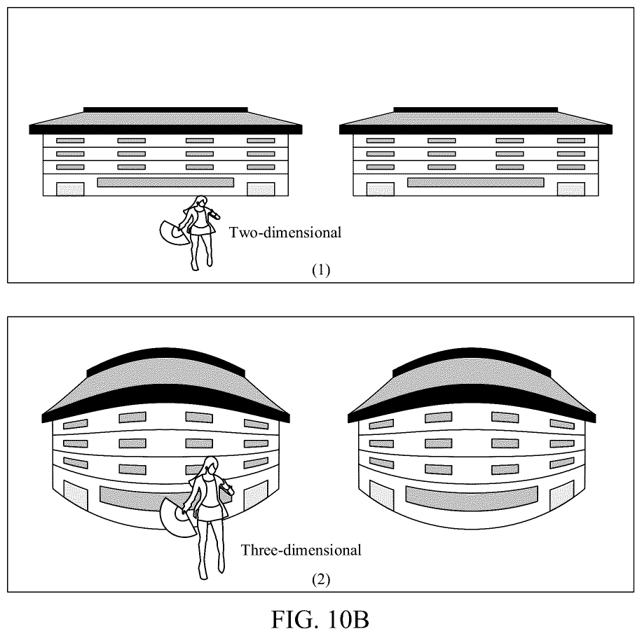

The foregoing embodiment of the present disclosure is applied. (1) A real person with virtual-real fusion has a correct occlusion relationship in the virtual world, improving image quality. Referring to FIG. 10A, a human body depth map may be used to distort a real-person layer in a virtual world, to make the real-person layer three-dimensional, and make an occlusion relationship of the real-person layer the same as that of a human body skeleton, to ensure that there is a correct occlusion relationship between a real human body and a virtual object (for example, a virtual paper box shown in FIG. 10A (2)), thereby improving a picture effect during virtual interaction (for example, in fireball and gesture control). (2) High-quality 3D video and three-dimensional VR video can be rendered by using a virtual-real fusion technology. Referring to FIG. 10B, when a real-person layer corrected by using a human body depth map is used to render a 360 panoramic video or a three-dimensional VR360 video, a real person can be changed from two-dimensional image to a three-dimensional image (as shown in FIG. 10B (1) to FIG. 10B (2)), achieving a real three-dimensional VR effect. (3) While improving image quality of virtual-real fusion, ease of use is not reduced. Compared with the binocular camera solution, there is no need to calibrate the binocular camera, and use of the binocular camera is simple. Compared with the use of the depth sensor, there is no need to calibrate a spatial relationship between the depth camera and the RGB camera, which is simple to use. 4) While improving image quality of virtual-real fusion, hardware costs are not increased. Compared with the binocular camera solution, only one camera and lens is required, which saves hardware costs. Compared with a solution using a depth sensor, there is no need to use the depth sensor, which also saves hardware costs.

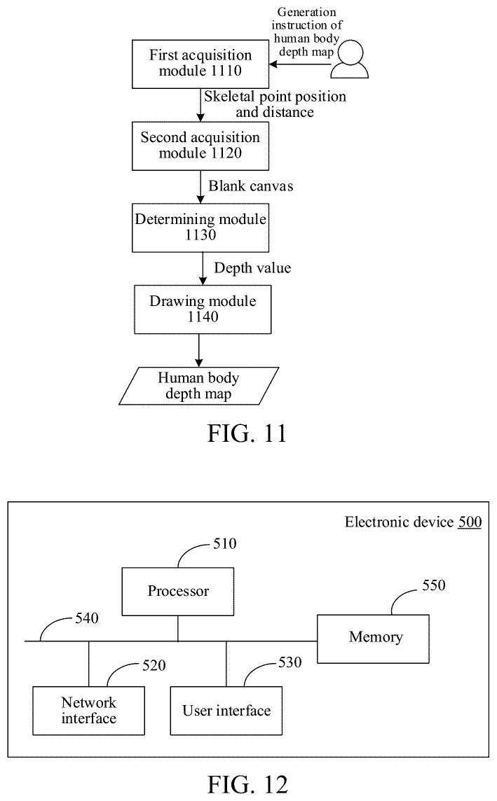

An apparatus for generating a human body depth map according to an embodiment of the present disclosure is described below. FIG. 11 is a schematic structural diagram of an apparatus for generating a human body depth map according to an embodiment of the present disclosure. The apparatus for generating a human body depth map according to an embodiment of the present disclosure includes: a first acquisition module 1110, configured to acquire a skeletal point position of a skeletal point in a skeleton of a target object in a two-dimensional image coordinate system, and acquire a distance from each skeletal point to a camera imaging plane in a three-dimensional camera coordinate system; a second acquisition module 1120, configured to acquire a blank canvas for drawing a human body depth map; a determining module 1130, configured to determine a depth value of each first pixel point of the skeleton based on the skeletal point position and the distance of each skeletal point; and a drawing module 1140, configured to draw in the blank canvas based on the depth value of each first pixel point, to obtain a human body depth map of the target object.

In some embodiments, the second acquisition module 1120 is configured to: acquire a target resolution of a to-be-generated human body depth map; and create a blank canvas having the target resolution and for drawing the human body depth map.

In some embodiments, the skeleton is formed by connecting a plurality of skeletal line segments, and two endpoints of the skeletal line segment are respectively a first skeletal point and a second skeletal point in the skeleton. The determining module 1130 is further configured to respectively perform the following processing for each skeletal line segment point on each of the plurality of skeletal line segments in the skeleton: acquiring a line segment point position of the skeletal line segment point in the two-dimensional image coordinate system; determining a first distance between the skeletal line segment point and the first skeletal point based on the line segment point position and a skeletal point position of the first skeletal point; determining a second distance between the skeletal line segment point and the second skeletal point based on the line segment point position and a skeletal point position of the second skeletal point; and determining the depth value of the first pixel point of the skeletal line segment point based on the first distance, the second distance, a distance from the first skeletal point to the camera imaging plane, and a distance from the second skeletal point to the camera imaging plane.

In some embodiments, the determining module 1130 is further configured to: use the first distance as a first weight value of the distance from the first skeletal point to the camera imaging plane, and use the second distance as a second weight value of the distance from the second skeletal point to the camera imaging plane; perform weighted averaging processing on the distance from the first skeletal point to the camera imaging plane and the distance from the second skeletal point to the camera imaging plane based on the first weight value and the second weight value, to obtain a weighted averaging result; and use the weighted averaging result as the depth value of the first pixel point of the skeletal line segment point.

In some embodiments, the skeleton is formed by connecting the plurality of skeletal line segments, and the skeleton includes: a polygonal skeletal region enclosed by at least three skeletal line segments connected by skeletal points, where vertexes of the polygonal skeletal region are the skeletal points; and the determining module 1130 is further configured to divide the polygonal skeletal region into at least one triangular skeletal region, and respectively perform the following processing for each triangular skeletal region to obtain the depth value of each first pixel point of the polygonal skeletal region of the skeleton: determining a depth value of each first pixel point of the triangular skeletal region of the skeleton based on the skeletal point position of each vertex of the triangular skeletal region and the distance.

In some embodiments, the skeletal point position of each vertex of the triangular skeletal region is represented by a skeletal point coordinate value; and the determining module 1130 is further configured to respectively perform the following processing for each first pixel point of the triangular skeletal region: acquiring a pixel point coordinate value of the first pixel point in the blank canvas; determining, based on the pixel point coordinate value and the skeletal point coordinate value of each vertex of the triangular skeletal region, a weight value of each vertex corresponding to the first pixel point, the weight value of the vertex being a weight value of a distance from the vertex to the camera imaging plane; performing weighted summation on the distance from each vertex to the camera imaging plane based on the weight value of each vertex corresponding to the first pixel point, to obtain a weighted summation result; and using the weighted summation result as the depth value of the first pixel point of the triangular skeletal region.

In some embodiments, the drawing module 1140 is further configured to respectively perform the following processing for the depth value of each first pixel point of the triangular skeletal region: when the weight value of each vertex corresponding to the first pixel point is not less than 0, drawing in the blank canvas based on the depth value of the first pixel point, to obtain the human body depth map of the target object.

In some embodiments, the drawing module 1140 is further configured to: draw each first pixel point in the blank canvas based on the depth value of each first pixel point, to obtain a skeletal depth map; and draw, based on the depth value of each first pixel point, a second pixel point in a region other than each first pixel point in the skeletal depth map, to obtain the human body depth map of the target object.

In some embodiments, the drawing module 1140 is further configured to respectively perform the following processing for each first pixel point, to obtain the skeletal depth map: determining a to-be-drawn position of the first pixel point in the blank canvas, and determining a target pixel point located at the to-be-drawn position from the blank canvas; and determining a depth value of the target pixel point as the depth value of the first pixel point.

In some embodiments, the drawing module 1140 is further configured to: before the determining a depth value of the target pixel point as the depth value of the first pixel point, when no other pixel point is drawn at the target pixel point, determine that an operation of determining the depth value of the target pixel point as the depth value of the first pixel point is to be performed; when another pixel point has been drawn at the target pixel point, acquire a target depth value of the another pixel point that has been drawn at the target pixel point; and when the target depth value is greater than the depth value of the first pixel point, determine that an operation of determining the depth value of the target pixel point as the depth value of the first pixel point is to be performed; and the drawing module 1140 is further configured to keep the target depth value unchanged when the target depth value is not greater than the depth value of the first pixel point.

In some embodiments, the drawing module 1140 is further configured to: perform depth value diffusion on the depth value of each first pixel point to each target pixel point in a region other than each first pixel point in the skeletal depth map, to obtain the depth value of each target pixel point; and draw each target pixel point in the skeletal depth map based on the depth value of each target pixel point, and use the drawn target pixel point as the second pixel point, to obtain the human body depth map of the target object.

In some embodiments, the depth value diffusion includes N rounds of depth value diffusion, and the drawing module 1140 is further configured to: for a first round of depth value diffusion of the N rounds of depth value diffusion, perform depth value diffusion on the depth value of each first pixel point to a neighborhood pixel point of each first pixel point, to obtain a depth value of the neighborhood pixel point of each first pixel point, and use the depth value of the neighborhood pixel point of each first pixel point as a depth value of the first round of target pixel point; and for an i^{th} round of depth value diffusion of the N rounds of depth value diffusion, perform depth value diffusion on a depth value of an (i−1)^{th} round of target pixel point to a neighborhood pixel point of the (i−1)^{th} round of target pixel point, to obtain a depth value of the neighborhood pixel point of the (i−1)^{th} round of target pixel point, and use the depth value of the neighborhood pixel point of the (i−1)^{th} round of target pixel point as a depth value of the i^{th} round of target pixel point, where N and i are integers greater than 0, and N is greater than or equal to i.

In some embodiments, the drawing module 1140 is further configured to respectively perform the following processing for each neighborhood pixel point to which the depth value of the first pixel point is diffused: determining at least one target first pixel point whose depth value is diffused to the neighborhood pixel point; and performing weighted averaging processing on the depth value of the at least one target first pixel point, to obtain a depth value of the neighborhood pixel point.

The foregoing embodiment of the present disclosure is applied. First, a skeletal point position of each skeletal point in a skeleton of a target object in a two-dimensional image coordinate system, a distance from each skeletal point to a camera imaging plane in a three-dimensional camera coordinate system, and a blank canvas for drawing a human body depth map are acquired. Then, a depth value of each first pixel point of the skeleton is determined based on the skeletal point position and the distance of each skeletal point, so that drawing is performed in the blank canvas based on the depth value of each first pixel point, to obtain a human body depth map of the target object. In this way, only the skeletal point position of each skeletal point in the skeleton of the target object in the two-dimensional image coordinate system and the distance from each skeletal point to the camera imaging plane in the three-dimensional camera coordinate system need to be calculated, to generate the human body depth map of the target object. Compared with generation of the human body depth map through training and inference of a deep learning model, time consumption, occupation and requirements of hardware resources for the disclosed embodiment are reduced, thereby improving generation efficiency of the human body depth map, and reducing generation costs of the human body depth map.

An electronic device for implementing a method for generating a human body depth map according to an embodiment of the present disclosure is described below. FIG. 12 is a schematic structural diagram of an electronic device 500 for implementing a method for generating a human body depth map according to an embodiment of the present disclosure. The electronic device 500 may be a server, or a terminal. The electronic device 500 for implementing a method for generating a human body depth map according to an embodiment of the present disclosure includes: at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 further includes a power bus, a control bus, and a state signal bus. However, for ease of clear description, all types of buses are marked as the bus system 540 in FIG. 12.

The processor 510 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any processor, or the like.

The memory 550 may be a removable memory, a non-removable memory, or a combination thereof. In some embodiments, the memory 550 includes one or more storage devices away from the processor 510 in a physical position. The memory 550 includes a volatile memory or a non-volatile memory, or may include both a volatile memory and a non-volatile memory. The non-volatile memory may be a read only memory (ROM). The volatile memory may be a random access memory (RAM). The memory 550 described in this embodiment of the present disclosure is to include any other suitable type of memories.

The memory 550 can store data to support various operations. Examples of the data include a program, a module, and a data structure, or a subset or a superset thereof. In this embodiment of the present disclosure, the memory 550 stores computer-executable instructions. When the computer-executable instructions are executed by the processor 510, the processor 510 is caused to perform the method for generating a human body depth map provided in this embodiment of the present disclosure.

An embodiment of the present disclosure further provides a computer program product, where the computer program product includes computer-executable instructions, and the computer-executable instructions are stored in a computer-readable storage medium. A processor of an electronic device reads the computer-executable instructions from the computer-readable storage medium, and executes the computer-executable instructions, to cause the electronic device to perform the method for generating a human body depth map provided in the embodiments of the present disclosure.

An embodiment of the present disclosure further provides a computer-readable storage medium, where the computer-readable storage medium has computer-executable instructions stored therein, and the computer-executable instructions, when executed by a processor, implement the method for generating a human body depth map provided in the embodiments of the present disclosure.

In some embodiments, the computer-readable storage medium may be a memory such as a RAM, a ROM, a flash memory, a magnetic surface memory, an optical disk, or a CD-ROM; or may be any device including one of or any combination of the foregoing memories.

In some embodiments, the computer-executable instructions may be written in a form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is specially configured for a program in discussion, or stored in a plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

The foregoing descriptions are merely embodiments of the present disclosure and are not intended to limit the protection scope of the present disclosure. Any modification, equivalent replacement, or improvement made without departing from the spirit and range of the present disclosure shall fall within the protection scope of the present disclosure.

What is claimed is:

1. A method for generating a human body depth map, applied to an electronic device, the method comprising:
acquiring a skeletal point position of each skeletal point in a skeleton of a target object in a two-dimensional image coordinate system, and acquiring a distance from each skeletal point to a camera imaging plane in a three-dimensional camera coordinate system;
acquiring a blank canvas for drawing the human body depth map;
determining a depth value of each first pixel point of the skeleton based on the skeletal point position and the distance of each skeletal point; and
drawing in the blank canvas based on the depth value of each first pixel point, to obtain a human body depth map of the target object.

2. The method according to claim 1, wherein the acquiring a blank canvas for drawing the human body depth map comprises:
acquiring a target resolution of the human body depth map to be generated; and
creating a blank canvas having the target resolution and for drawing the human body depth map.

3. The method according to claim 1, wherein the skeleton is formed by connecting a plurality of skeletal line segments, and two endpoints of the skeletal line segment are respectively a first skeletal point and a second skeletal point in the skeleton; and
the determining a depth value of each first pixel point of the skeleton based on the skeletal point position and the distance of each skeletal point comprises:
for each skeletal line segment point on each of the plurality of skeletal line segments in the skeleton, respectively performing:
acquiring a line segment point position of the skeletal line segment point in the two- dimensional image coordinate system;
determining a first distance between the skeletal line segment point and the first skeletal point based on the line segment point position and a skeletal point position of the first skeletal point;
determining a second distance between the skeletal line segment point and the second skeletal point based on the line segment point position and a skeletal point position of the second skeletal point; and
determining the depth value of the first pixel point of the skeletal line segment point based on the first distance, the second distance, a distance from the first skeletal point to the camera imaging plane, and a distance from the second skeletal point to the camera imaging plane.

4. The method according to claim 3, wherein the determining the depth value of the first pixel point of the skeletal line segment point based on the first distance, the second distance, a distance from the first skeletal point to the camera imaging plane, and a distance from the second skeletal point to the camera imaging plane comprises:
using the first distance as a first weight value of the distance from the first skeletal point to the camera imaging plane, and using the second distance as a second weight value of the distance from the second skeletal point to the camera imaging plane;
performing weighted averaging processing on the distance from the first skeletal point to the camera imaging plane and the distance from the second skeletal point to the camera imaging plane based on the first weight value and the second weight value, to obtain a weighted averaging result; and
using the weighted averaging result as the depth value of the first pixel point of the skeletal line segment point.

5. The method according to claim 1, wherein the skeleton is formed by connecting the plurality of skeletal line segments, and the skeleton comprises: a polygonal skeletal region enclosed by at least three skeletal line segments connected by skeletal points, wherein vertexes of the polygonal skeletal region are the skeletal points; and
the determining a depth value of each first pixel point of the skeleton based on the skeletal point position and the distance of each skeletal point comprises:
dividing the polygonal skeletal region into at least one triangular skeletal region, and respectively performing the following processing for each triangular skeletal region to obtain the depth value of each first pixel point of the polygonal skeletal region of the skeleton:
determining the depth value of each first pixel point of the triangular skeletal region of the skeleton based on the skeletal point position of each vertex of the triangular skeletal region and the distance.

6. The method according to claim 5, wherein the skeletal point position of each vertex of the triangular skeletal region is represented by a skeletal point coordinate value; and the determining the depth value of each first pixel point of the triangular skeletal region of the skeleton based on the skeletal point position of each vertex of the triangular skeletal region and the distance comprises:
respectively performing the following processing for each first pixel point of the triangular skeletal region:
acquiring a pixel point coordinate value of the first pixel point in the blank canvas;
determining, based on the pixel point coordinate value and the skeletal point coordinate value of each vertex of the triangular skeletal region, a weight value of each vertex corresponding to the first pixel point, the weight value of the vertex being a weight value of a distance from the vertex to the camera imaging plane;
performing weighted summation on the distance from each vertex to the camera imaging plane based on the weight value of each vertex corresponding to the first pixel point, to obtain a weighted summation result; and
using the weighted summation result as the depth value of the first pixel point of the triangular skeletal region.

7. The method according to claim 6, wherein the drawing in the blank canvas based on the depth value of each first pixel point, to obtain a human body depth map of the target object comprises:
respectively performing the following processing for the depth value of each first pixel point of the triangular skeletal region:
when the weight value of each vertex corresponding to the first pixel point is not less than 0, drawing in the blank canvas based on the depth value of the first pixel point, to obtain the human body depth map of the target object.

8. The method according to claim 1, wherein the drawing in the blank canvas based on the depth value of each first pixel point, to obtain a human body depth map of the target object comprises:
drawing, based on the depth value of each first pixel point, each first pixel point in the blank canvas, to obtain a skeletal depth map; and
drawing, based on the depth value of each first pixel point, a second pixel point in a region other than each first pixel point in the skeletal depth map, to obtain the human body depth map of the target object.

9. The method according to claim 8, wherein the drawing, based on the depth value of each first pixel point, each first pixel point in the blank canvas, to obtain a skeletal depth map comprises:
respectively performing the following processing for each first pixel point to obtain the skeletal depth map:
determining a candidate position to draw the first pixel point in the blank canvas, and determining a target pixel point located at the candidate position from the blank canvas; and
determining a depth value of the target pixel point as the depth value of the first pixel point.

10. The method according to claim 9, further comprising:
when no pixel point is drawn at the target pixel point, determining that an operation of determining the depth value of the target pixel point as the depth value of the first pixel point is to be performed; or
when another pixel point has been drawn at the target pixel point, acquiring a target depth value of the another pixel point that has been drawn at the target pixel point, and in response to that the target depth value is greater than the depth value of the first pixel point, determining the depth value of the target pixel point as the depth value of the first pixel point; and in response to that
the target depth value is not greater than the depth value of the first pixel point, keeping the target depth value unchanged.

11. The method according to claim 8, wherein the drawing, based on the depth value of each first pixel point, a second pixel point in a region other than each first pixel point in the skeletal depth map, to obtain the human body depth map of the target object comprises: for one first pixel point
performing depth value diffusion on the depth value of the one first pixel point to a target pixel point in a region other than the one first pixel point in the skeletal depth map, to obtain the depth value of the target pixel point; and
drawing the target pixel point in the skeletal depth map based on the depth value of the target pixel point, and using the drawn target pixel point as the second pixel point, to obtain the human body depth map of the target object.

12. The method according to claim 11, wherein the depth value diffusion comprises N rounds of depth value diffusion, and the performing depth value diffusion on the depth value of each first pixel point to each target pixel point in the region other than each first pixel point in the skeletal depth map, to obtain the depth value of each target pixel point comprises:
for a first round of depth value diffusion of the N rounds of depth value diffusion, performing depth value diffusion on the depth value of each first pixel point to a neighborhood pixel point of each first pixel point, to obtain a depth value of the neighborhood pixel point of each first pixel point, and using the depth value of the neighborhood pixel point of each first pixel point as a depth value of a first round of target pixel point; and
for an i^{th} round of depth value diffusion of the N rounds of depth value diffusion, performing depth value diffusion on a depth value of an (i−1)^{th} round of target pixel point to a neighborhood pixel point of the (i−1)^{th} round of target pixel point, to obtain a depth value of the neighborhood pixel point of the (i−1)^{th} round of target pixel point, and using the depth value of the neighborhood pixel point of the (i−1)^{th} round of target pixel point as a depth value of an i^{th} round of target pixel point, wherein
N and i are integers greater than 0, and N is greater than or equal to i.

13. The method according to claim 12, wherein the performing depth value diffusion on the depth value of each first pixel point to a neighborhood pixel point of each first pixel point, to obtain a depth value of the neighborhood pixel point of each first pixel point comprises:
respectively performing the following processing for each neighborhood pixel point to which the depth value of the first pixel point is diffused:
determining at least one target first pixel point whose depth value is diffused to the neighborhood pixel point; and
performing weighted averaging processing on the depth value of the at least one target first pixel point, to obtain the depth value of the neighborhood pixel point.

14. An apparatus for generating a human body depth map, comprising:
a memory, configured to store computer-executable instructions; and
a processor, configured to, when executing the computer-executable instructions stored in the memory, implement:
acquiring a skeletal point position of each skeletal point in a skeleton of a target object in a two-dimensional image coordinate system, and acquiring a distance from each skeletal point to a camera imaging plane in a three-dimensional camera coordinate system;
acquiring a blank canvas for drawing the human body depth map;
determining a depth value of each first pixel point of the skeleton based on the skeletal point position and the distance of each skeletal point; and
drawing in the blank canvas based on the depth value of each first pixel point, to obtain a human body depth map of the target object.

15. The apparatus according to claim 14, wherein the acquiring a blank canvas for drawing the human body depth map comprises:
acquiring a target resolution of the human body depth map to be generated; and
creating a blank canvas having the target resolution and for drawing the human body depth map.

16. The apparatus according to claim 14, wherein the skeleton is formed by connecting a plurality of skeletal line segments, and two endpoints of the skeletal line segment are respectively a first skeletal point and a second skeletal point in the skeleton; and
the determining a depth value of each first pixel point of the skeleton based on the skeletal point position and the distance of each skeletal point comprises:
for each skeletal line segment point on each of the plurality of skeletal line segments in the skeleton, respectively performing:
acquiring a line segment point position of the skeletal line segment point in the two- dimensional image coordinate system;
determining a first distance between the skeletal line segment point and the first skeletal point based on the line segment point position and a skeletal point position of the first skeletal point;
determining a second distance between the skeletal line segment point and the second skeletal point based on the line segment point position and a skeletal point position of the second skeletal point; and
determining the depth value of the first pixel point of the skeletal line segment point based on the first distance, the second distance, a distance from the first skeletal point to the camera imaging plane, and a distance from the second skeletal point to the camera imaging plane.

17. The apparatus according to claim 16, wherein the determining the depth value of the first pixel point of the skeletal line segment point based on the first distance, the second distance, a distance from the first skeletal point to the camera imaging plane, and a distance from the second skeletal point to the camera imaging plane comprises:
using the first distance as a first weight value of the distance from the first skeletal point to the camera imaging plane, and using the second distance as a second weight value of the distance from the second skeletal point to the camera imaging plane;
performing weighted averaging processing on the distance from the first skeletal point to the camera imaging plane and the distance from the second skeletal point to the camera imaging plane based on the first weight value and the second weight value, to obtain a weighted averaging result; and
using the weighted averaging result as the depth value of the first pixel point of the skeletal line segment point.

18. The apparatus according to claim 14, wherein the skeleton is formed by connecting the plurality of skeletal line segments, and the skeleton comprises: a polygonal skeletal region enclosed by at least three skeletal line segments connected by skeletal points, wherein vertexes of the polygonal skeletal region are the skeletal points; and
the determining a depth value of each first pixel point of the skeleton based on the skeletal point position and the distance of each skeletal point comprises:
dividing the polygonal skeletal region into at least one triangular skeletal region, and respectively performing the following processing for each triangular skeletal region to obtain the depth value of each first pixel point of the polygonal skeletal region of the skeleton:
determining the depth value of each first pixel point of the triangular skeletal region of the skeleton based on the skeletal point position of each vertex of the triangular skeletal region and the distance.

19. The apparatus according to claim 18, wherein the skeletal point position of each vertex of the triangular skeletal region is represented by a skeletal point coordinate value; and the determining the depth value of each first pixel point of the triangular skeletal region of the skeleton based on the skeletal point position of each vertex of the triangular skeletal region and the distance comprises:
respectively performing the following processing for each first pixel point of the triangular skeletal region:
acquiring a pixel point coordinate value of the first pixel point in the blank canvas;
determining, based on the pixel point coordinate value and the skeletal point coordinate value of each vertex of the triangular skeletal region, a weight value of each vertex corresponding to the first pixel point, the weight value of the vertex being a weight value of a distance from the vertex to the camera imaging plane;
performing weighted summation on the distance from each vertex to the camera imaging plane based on the weight value of each vertex corresponding to the first pixel point, to obtain a weighted summation result; and
using the weighted summation result as the depth value of the first pixel point of the triangular skeletal region.

20. A non-transitory computer-readable storage medium, having computer-executable instructions stored therein, the computer-executable instructions, when executed by a processor, causing the processor to implement:
acquiring a skeletal point position of each skeletal point in a skeleton of a target object in a two-dimensional image coordinate system, and acquiring a distance from each skeletal point to a camera imaging plane in a three-dimensional camera coordinate system;
acquiring a blank canvas for drawing the human body depth map;
determining a depth value of each first pixel point of the skeleton based on the skeletal point position and the distance of each skeletal point; and
drawing in the blank canvas based on the depth value of each first pixel point, to obtain a human body depth map of the target object.
